(19) United States
(12) Patent Application Publication
(10) Pub. No.: US 2018/0114123 A1
(43) Pub. Date: Apr. 26, 2018

(54) RULE GENERATION METHOD AND APPARATUS USING DEEP LEARNING

(71) Applicant: SAMSUNG SDS CO., LTD., Seoul (KR)

(72) Inventors: Myung Soo KIM, Seoul (KR); Tae Hwan JEONG, Seoul (KR); Gyeong Seon CHO, Seoul (KR)

(73) Assignee: SAMSUNG SDS CO., LTD., Seoul (KR)

(21) Appl. No.: 15/791,800

(22) Filed: Oct. 24, 2017

(30) Foreign Application Priority Data
Oct. 24, 2016 (KR) 10-2016-0138626

(51) Int. Cl. G06N 5/02

(52) U.S. Cl. CPC G06N 5/025; G06N 5/027

(57) ABSTRACT

A method and apparatus for generating optimized rules by comparing result data obtained using an existing rule set and result data obtained using a rule set learned through deep learning is provided. A rule generation method of a rule generation apparatus comprises obtaining first result data by executing a rule engine on input data based on a predetermined first rule set, generating a training rule set by analyzing the input data using a deep learning module, obtaining second result data by executing the rule engine on the input data based on the generated training rule set comparing the first result data and the second result data and based on a result of the comparison, updating the predetermined first rule set to a second rule set using the training rule set.

This application claims priority to Korean Patent Application No. 10-2016-0138626, filed on Oct. 24, 2016, and all the benefits accruing therefrom under 35 U.S.C. § 119, the disclosure of which is incorporated herein by reference in its entirety.

### BACKGROUND

### 1. Field

The present disclosure relates to a rule generation method and apparatus using deep learning, and more particularly, to a rule generation method and apparatus for generating rules by updating a rule set through deep learning.

### 2. Description of the Related Art

In the business environment, a rule engine is used to make a smooth decision based on various factors. The rule engine executes a rule set, which is a set of rules, on input data and provides the result of the execution to a decision maker so as for the decision maker to determine the influence of the input value on his or her business.

The rule set of the rule engine can be updated by, for example, adding new rules thereto or revising or deleting existing rules therefrom in accordance with changes in the business environment, development of new criteria, and the like. In order to update the rule set, the error and analysis accuracy of each rule of the rule set need to be determined, and this type of determination is generally made manually by a rule set manager.

However, as the amount of data input to the rule engine becomes enormous and rules executed by the rule engine become highly complicated and increasingly diversify, there are limits in recognizing error in each individual rule and the accuracy of analysis and then updating a rule set manually.

And yet, there is not provided a technique for generating an optimized rule set by identifying rule error that is not easily recognizable by humans, using an analysis method for a vast amount of data such as deep learning.

### SUMMARY

Exemplary embodiments of the present disclosure provide a rule generation method and apparatus using a deep learning technique.

Specifically, exemplary embodiments of the present disclosure provide a method and apparatus for generating optimized rules by comparing result data obtained using an existing rule set and result data obtained using a rule set learned through deep learning.

Exemplary embodiments of the present disclosure also provide a method and apparatus for converting multidimensional result data to one dimension for comparing result data obtained using an existing rule set and result data obtained using a rule set learned through deep learning.

Specifically, exemplary embodiments of the present disclosure also provide a method and apparatus for determining the reliability of a rule set by plotting a one-dimensional graph based on result data obtained using the existing rule set and result data obtained using a rule set learned through deep learning.

Exemplary embodiments of the present disclosure also provide a method and apparatus for generating optimized rules by reflecting analysis results obtained using various analytic functions in existing rules.

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to an exemplary embodiment of the present disclosure,

According to the aforementioned and other exemplary embodiments of the present disclosure, a determination can be automatically made as to whether various complicated rule sets are erroneous by using deep learning.

Also, a rule set can be optimized by deleting unnecessary rules therefrom according to changes in the business environment.

Also, new rules can be learned by analyzing result data obtained by executing a rule set learned through deep learning. Since newly learned rules can be included in an existing rule set, the performance of a rule engine can be improved.

Also, result data with an improved accuracy can be obtained by analyzed rules in a rule set using various analytic functions and reflecting the result of the analysis in the rule set.

Also, since result data obtained using a rule set can be provided to a rule engine manager in the form of a one-dimensional (1D) graph, information regarding any error in the rule set can be intuitively identified.

Other features and exemplary embodiments may be apparent from the following detailed description, the drawings, and the claims.

### BRIEF DESCRIPTION OF THE DRAWINGS

The above and other exemplary embodiments and features of the present disclosure will become more apparent by describing in detail exemplary embodiments thereof with reference to the attached drawings, in which:

FIG. 1 is a functional block diagram of a rule generation apparatus according to an exemplary embodiment of the present disclosure;

FIG. 2 is a hardware configuration diagram of the rule generation apparatus according to the exemplary embodiment of FIG. 1;

FIG. 3 is a flowchart illustrating a rule generation method according to an exemplary embodiment of the present disclosure;

FIG. 4 is a conceptual diagram for explaining the rule generation method according to the exemplary embodiment of FIG. 3;

FIG. 5 shows rule sets according to some exemplary embodiments of the present disclosure;

FIG. 6 shows graphs showing result data obtained using a predefined rule set that is set up in advance;

FIGS. 7A through 7D are diagrams for explaining result data obtained using a rule set learned through deep learning;

FIG. 8 shows an exemplary graph comparing result data obtained using a predefined rule set that is set up in advance and result data obtained using a learned rule set, according to some exemplary embodiments of the present disclosure;

FIG. 9 shows another exemplary graph comparing result data obtained using a predefined rule set that is set up in advance and result data obtained using a learned rule set, according to some exemplary embodiments of the present disclosure;

FIG. 10 is a diagram comparing a predefined rule set that is set up in advance and a learned rule set according to some exemplary embodiments of the present disclosure;

FIG. 11 is a diagram for explaining analytic functions that can be used in some exemplary embodiments of the present disclosure;

FIG. 12 is a diagram showing analysis result data obtained by deep learning and analysis result data obtained using the analytic functions;

FIG. 13 is a diagram showing result data obtained using an optimized rule set according to some exemplary embodiments of the present disclosure; and

FIG. 14 is a diagram for explaining the optimized rule set according to some exemplary embodiments of the present disclosure.

### DETAILED DESCRIPTION

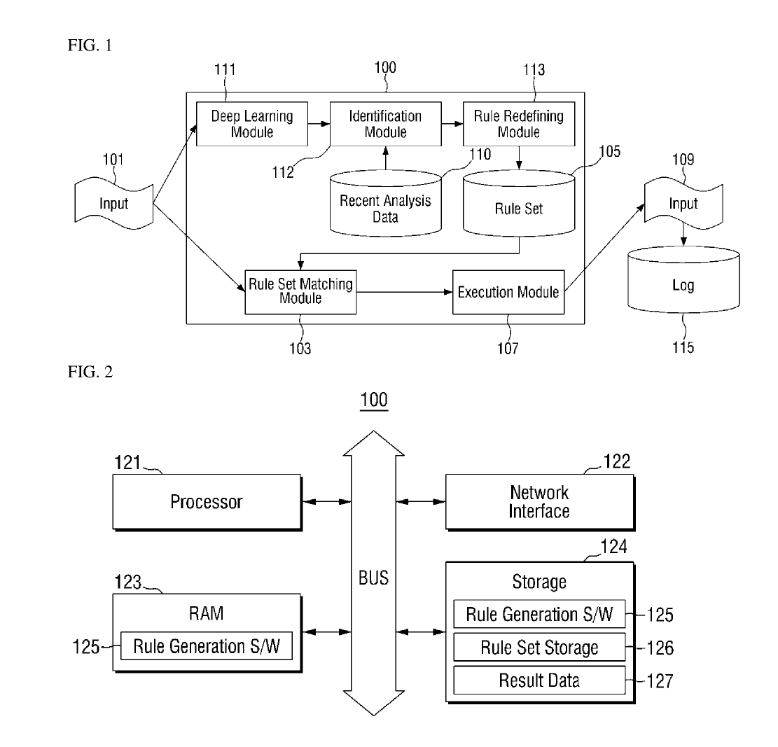

FIG. 1 is a functional block diagram of a rule generation apparatus according to an exemplary embodiment of the present disclosure.

A rule generation apparatus 100 is a computing device capable of computing input data and obtaining and/or outputting result data. Referring to FIG. 1, the rule generation apparatus 100 may include a rule set matching module 103, a rule set 105, which is set up in advance, an execution module 107, a deep learning module 111, an identification module 112, and a rule redefining module 113.

The rule set matching module 103 matches a rule set to be executed, to input data 101 input to the rule generation apparatus 100. The rule set matching module 103 may acquire the rule set matched to the input data 101 from a database of rule sets 150. For example, when the input data 101 is a patient's medical data, the rule set matching module 103 may acquire the rule set 105, which consists of a plurality of rules set up in advance for determining whether the patient is ill, and may match the rule set 105 to the patient's medical data.

The execution module 107 executes each of the rules included in the rule set 105 matched to the input data 101. The execution module 107 may be configured to include a rule engine. The rule engine may be set up in advance to execute the rule set 105. Result data 109, which is obtained by executing the rule set 105 via the execution module 107, is generated. The result data 109 may be stored as a log 115. The result data 109 may be classified as recent analysis data 110 for comparison with result data obtained using a training rule set generated by the deep learning module 111.

The execution module 107 may execute the training rule set, which is generated for the input data 101 by using the deep learning module 111. Result data obtained by executing the training rule set is provided to the identification module 112.

The deep learning module 111 may generate the training rule set by analyzing the input data 101. That is, the deep learning module 111 may learn rules by analyzing the input data 101 and may generate a rule set consisting of the learned rules as the training rule set. To this end, the deep learning module 111 may infer rules by analyzing the input data 101 and the result data 109 based on the rule set 105.

The deep learning module 111 may also analyze the result data 109 to add new rules to, and/or to revise or delete existing rules from, the rule set 105 based on the learned rules.

The deep learning module 111 may be implemented as at least one of various modules that are already well known in the art. For example, the deep learning module 111 may perform unsupervised learning using neural networks technology.

The identification module 112 may compare the recent analysis data 110 with the result data obtained using the training rule set. In this manner, the identification module 112 can determine whether the result data 109 is abnormal.

In one exemplary embodiment, if there exists a difference level greater than a predefined reference level between the result data obtained using the training rule set and the recent analysis data 110, the identification module 112 may determine that the result data 109 is abnormal.

On the other hand, if the training rule set result data is similar to the recent analysis data 110, for example, if there exists only a difference level less than the predefined reference level between the result data obtained using the training rule set and the recent analysis data 110, the identification module 112 determines the result data 109 as being normal, and may store the result data 109 as the log 115

The rule redefining module 113 may add new rules to, and/or revise or delete existing rules from, the rule set 105 if the identification module 112 identifies any abnormality from the result data 109. That is, if the result data 109 is identified as being abnormal, the rule redefining module 113 may add new rules to, and/or revise or delete existing rules from, the rule set 105 in order to obtain normal result data. Any rule update made by the rule redefining module 113 are applied in the rule set 105.

FIG. 1 illustrates the elements of the rule generation apparatus 100 as being functional blocks, but the elements of the rule generation apparatus 100 may actually be software modules executed by the processor(s) of the rule generation apparatus 100 or hardware modules such as field programmable gate arrays (FPGAs) or application-specific integrated circuits (ASICs). However, the elements of the rule generation apparatus 100 are not particularly limited to being software or hardware modules. The elements of the rule generation apparatus 100 may be configured to reside in an addressable storage medium or to execute one or more processors. Each of the elements of the rule generation apparatus 100 may be divided into one or more sub-elements such that the functions of the corresponding element can be distributed between the sub-elements, or the elements of the rule generation apparatus 100 and the functions thereof may be incorporated into fewer elements.

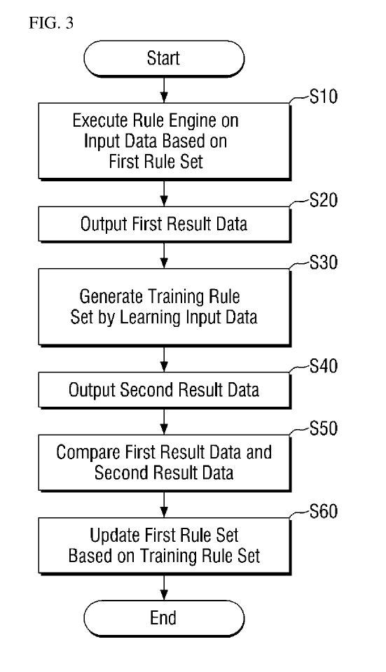

The detailed configuration and operation of the rule generation apparatus 100 will hereinafter be described with reference to FIG. 2. FIG. 2 is a hardware configuration diagram of the rule generation apparatus 100.

Referring to FIG. 2, the rule generation apparatus 100 may include at least one processor 121, a network interface 122, a memory 123 loading a computer program executed by the processor 121, and a storage 124 storing rule generation software 125.

The processor 121 control the general operation of each of the elements of the rule generation apparatus 100. The processor 121 may be a central processing unit (CPU), a micro-processor unit (MPU), a micro-controller unit (MCU), or any other arbitrary processor that is already well known in the art. The processor 120 may perform computation on at least one application or program for executing a rule generation method according to an exemplary embodiment of the present disclosure. The rule generation apparatus 100 may include one or more processors 121.

The network interface 122 supports the wired/wireless Internet communication of the rule generation apparatus 100. The network interface 122 may also support various communication methods other than the Internet communication method. To this end, the network interface 122 may include a communication module that is already well known in the art.

The network interface 122 may receive the input data 101 of FIG. 1 via a network and may receive rules or a rule set according to an exemplary embodiment of the present disclosure. The network interface 122 may also receive various programs and/or applications such as the deep learning module 111, an analytic function, etc.

The memory 123 stores various data, instructions, and/or information. The memory 123 may load at least one program 125 from the storage 124 to execute the rule generation method according to an exemplary embodiment of the present disclosure. FIG. 2 illustrates a random access memory (RAM) as an example of the memory 123.

The storage 124 may non-temporarily store the program 125, a rule set, and result data 127. FIG. 2 illustrates the rule generation software 125 as an example of the program 125.

The storage 124 may be a nonvolatile memory such as a read only memory (ROM), an erasable programmable ROM (EPROM), an electrically erasable programmable ROM (EEPROM), or a flash memory, a hard disk, a removable disk, or another arbitrary computer-readable recording medium that is already well known in the art.

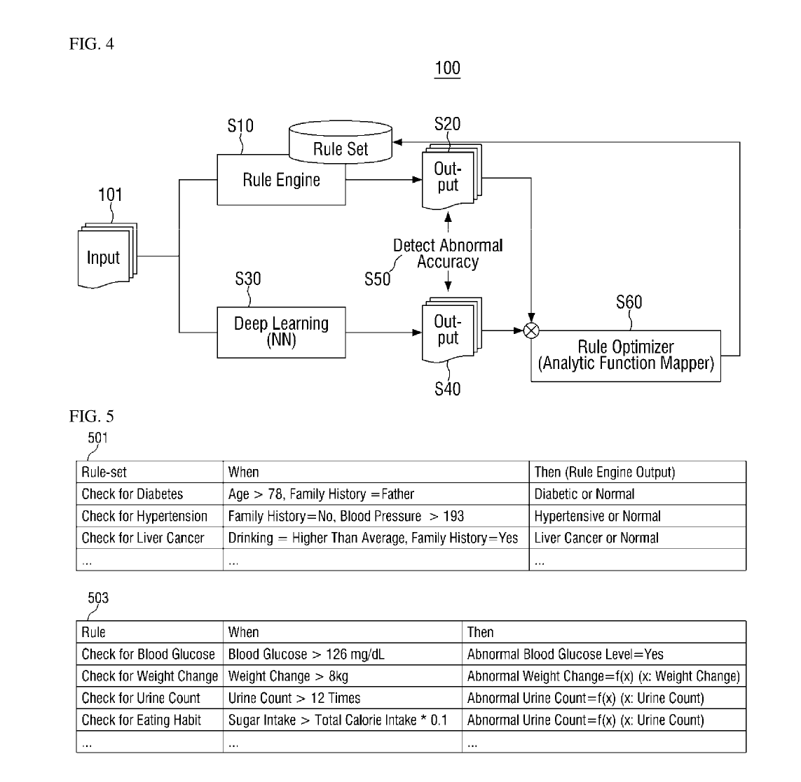

The rule generation software 125 may include operations performed by the functional blocks illustrated in FIG. 1. Operations performed by executing the rule generation software 125 of the processor 121 will be described later with reference to FIGS. 3 and 4.

The storage 124 may further include a rule set storage 126 storing a predefined rule set that is set up in advance and a training rule set generated through deep learning.

The storage 124 may store the result data 127, which is result data obtained by executing each of the predefined rule set and the training rule set for the input data 101. As described above with reference to FIG. 1, the result data 127 may be stored as a log.

The rule generation apparatus 100 may additionally include various elements other than those illustrated in FIG. 2. For example, the rule generation apparatus 100 may further include a display unit displaying graphs and charts with respect to the result data 127 to the administrator of the rule generation apparatus 100 and an input unit receiving various input for modifying a rule set from the administrator of the rule generation apparatus 100.

The rule generation method according to an exemplary embodiment of the present disclosure will hereinafter be described with reference to FIGS. 3 through 14. It is assumed that each step of the rule generation method according to an exemplary embodiment of the present disclosure is performed by the rule generation apparatus 100. Each step of the rule generation method according to an exemplary embodiment of the present disclosure may be an operation performed by the rule generation apparatus 100.

FIG. 3 is a flowchart illustrating a rule generation method according to an exemplary embodiment of the present disclosure. FIG. 4 is a conceptual diagram for explaining the rule generation method according to the exemplary embodiment of FIG. 3.

Referring to FIGS. 3 and 4, the rule generation apparatus 100 may execute a rule engine for input data 101 (S10) based on a predetermined first rule set and may thus obtain result data (S20). The result data obtained by executing the rule engine based on the first rule set will hereinafter be referred to as first result data in order to distinguish it from result data obtained by executing the rule engine based on a training rule set. Further, the rule generation apparatus 100 may output the result data.

The rule generation apparatus 100 may generate a training rule set by learning the input data 101 using the deep learning module 111 (S30). The deep learning module 111 may learn the input data 101 using neural networks technology. The deep learning module 111 may also generate the training rule set based on the result of learning the input data 101 and the first result data.

The rule generation apparatus 100 may obtain result data by executing the rule engine based on the training rule set (S40). FIG. 3 illustrates the rule engine as being used in S10, but the rule engine may also be used to execute the training rule set of the rule generation apparatus 100. The result data obtained by executing the rule engine based on the training rule set will hereinafter be referred to as second result data in order to distinguish it from the first result data. Further, the rule generation apparatus may output the result data.

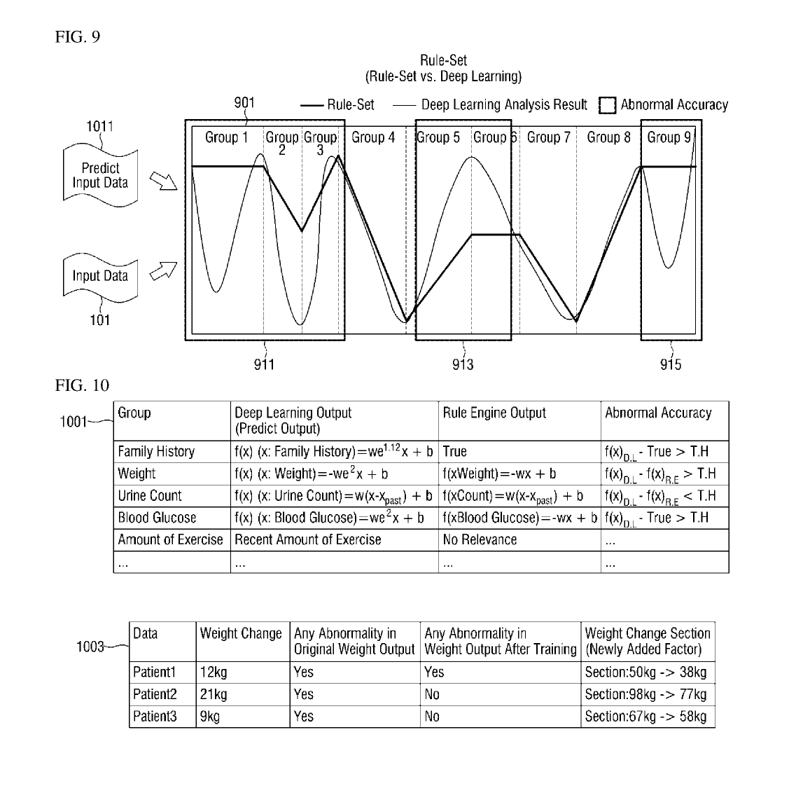

The rule generation apparatus 100 may compare the first result data obtained in S20 and the second result data obtained in S40 (S50). The rule generation apparatus 100 may determine whether result data is normal or abnormal based on the result of the comparison performed in S50. A method to determine whether the result data is normal or abnormal will be described later with reference to FIGS. 8 and 9.

The rule generation apparatus 100 may update the first rule set (S60) to a second rule set having the training rule set applied therein based on the result of the comparison performed in S50. Specifically, if result data is highly accurate as compared to actual measurement data, the rule generation apparatus 100 may update the first rule set based on the training rule set. Also, the rule generation apparatus 100 may update the first rule set to have some rules of the training rule set applied therein. As used herein, the term “update of a rule set” should be understood as encompassing the update of each individual rule included in the rule set.

Alternatively, the rule generation apparatus 100 may update the training rule set by learning the second result data. Still alternatively, the rule generation apparatus 100 may determine the accuracy of the second result data using an analytic function and may then update the training rule set using result data obtained using the analytic function.

FIG. 5 shows rule sets according to some exemplary embodiments of the present disclosure.

Referring to FIG. 5, a rule set 501 is an exemplary rule set that is set up in advance for checking for chronic diseases. A rule set 503 is an exemplary rule set that is set up in advance for checking for diabetes, among other chronic diseases. The rule set 501, like the rule set 503, may be a set of individual rules. Each rule that constitutes the rule set 501 or 503 is a function obtaining result data (“then”) when the input data 101 meets a particular condition (“when”). The rule sets 501 and 503 will hereinafter be described, taking medical data as an example of the input data 101.

Referring to the rule set 501, if medical data of an examinee shows that the examinee is more than 78 years old and has a family history of diabetes from his or her father, result data is output indicating that the examinee is a subject for a check for diabetes.

If the medical data of the examinee shows that the examinee has no family history of diabetes but has a blood pressure of 193 or higher, result data is output indicating that the examinee is a subject for a check for hypertension.

It is assumed that according to the rule set 501, the result data indicating that the examinee is a subject for a check for diabetes is output. The rule set 503 is set up in advance to include various factors for the diagnosis of diabetes such as a check for blood glucose, a check for weight change, a check for urine count, and a check for eating habit as individual rules for checking the examinee for diabetes.

If the result of executing each of the rules of the rule set 503 for the medical data of the examinee shows that the examinee's blood glucose level, weight change, urine count, and glucose intake exceed 126 mg/dl, 8 kg, 12 times, and 10% of the total calorie intake, respectively, the rules of the rule set 503 output result data indicating that the examinee's blood glucose level, weight change, urine count, and eating habit are abnormal. Specifically, referring to the rule set 503, each of “check for weight change”, “check for urine count”, and “check for eating habit” rules are defined as a function f(x). The function f(x) may be referred to as a rule function, wherein x is input data on the examinee's medical data corresponding to each rule condition.

The rule generation apparatus 100 executes the rule sets 501 and 503 to obtain result data. If result data for the examinee's medical data classifies the examinee as being diabetic and the examinee is actually diabetic, the result data is determined to be normal and have a high rule accuracy.

On the other hand, if the result data classifies the examinee as being nondiabetic but the examinee is actually diabetic, the result data is determined to be abnormal and have a low rule accuracy. In this case, according to exemplary embodiments of the present disclosure, a training rule set may be generated through the deep learning of the result data, and the rules of the rule may be revised using the training rule set. In this manner, the accuracy of the rules of the rule can be improved. Also, the reliability of the result data can be enhanced by executing rules with high accuracy.

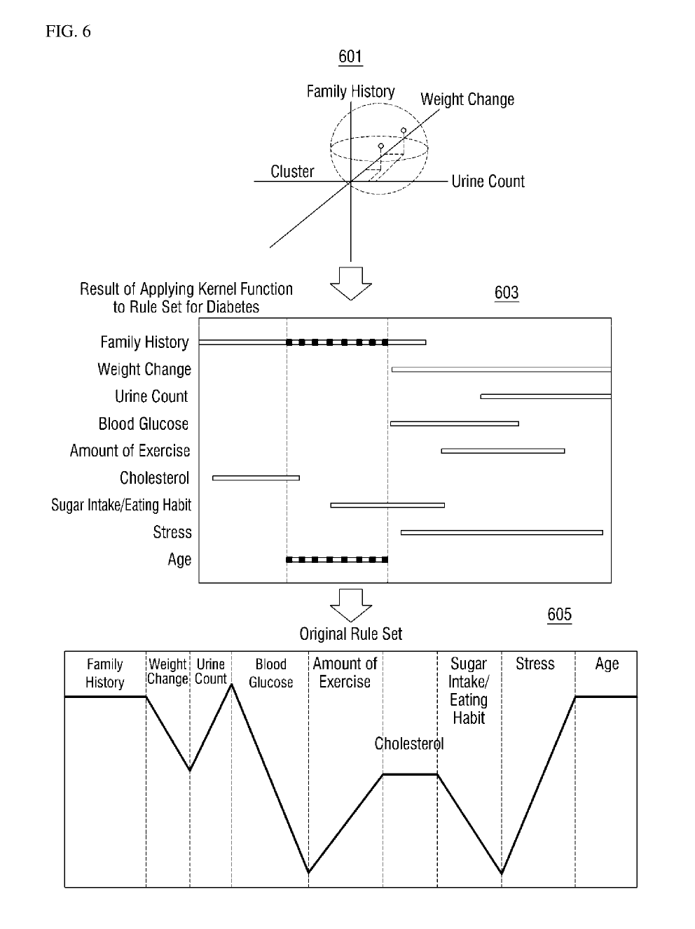

FIG. 6 shows graphs showing result data obtained using a predefined rule set that is set up in advance.

In S20, for the input data 101, the rule generation apparatus 100 may obtain n-dimensional result data by executing n rules included in the first rule set.

Referring to FIG. 6, a graph 601 represents result data obtained by the rule generation apparatus 100 in a case where a rule set having the “check for family history” rule, “check for weight change”, and “check for urine count” rules of FIG. 5 is the first rule set. Referring to the graph 601, result data obtained using the first rule set may be represented in a multidimensional space.

However, according to exemplary embodiments of the present disclosure, the rule generation apparatus 100 may generate a one-dimensional (1D) graph for the first result data obtained in S20 by applying a kernel function to n-dimensional result data.

The rule generation apparatus 100 may display the result data obtained using the first rule set as a 1D graph 603 by executing the kernel function on the n-dimensional result data.

The rule generation apparatus 100 may create a graph 603 in which the rule condition of each of the rules included in rule set is specified. For example, referring to the rule set 501 of FIG. 5, family history and age are set in advance as rule conditions for a rule set for checking for diabetes. In this case, the rule generation apparatus 100 may execute the kernel function, thereby identifying the rule conditions set, i.e., family history and age, and creating the graph 603. The graph 603 may also include rule conditions of the rule set 501 for other chronic diseases.

Referring to a graph 605, the rule generation apparatus 100 may execute the kernel function on the n-dimensional result data, thereby displaying result data for input data corresponding to each of the rules included in the first rule set as a 1D graph. Specifically, the rule generation apparatus 100 may apply the kernel function to the n-dimensional result data, thereby obtaining the graph 605, which is based on the rule conditions (“when”) of independent rules included in, for example, the rule set 503, and their respective results (“then”).

As described above, since the rule generation apparatus 100 can display result data as a 1D graph, the administrator of the rule generation apparatus 100 or a user can intuitively determine result data for each rule of input data.

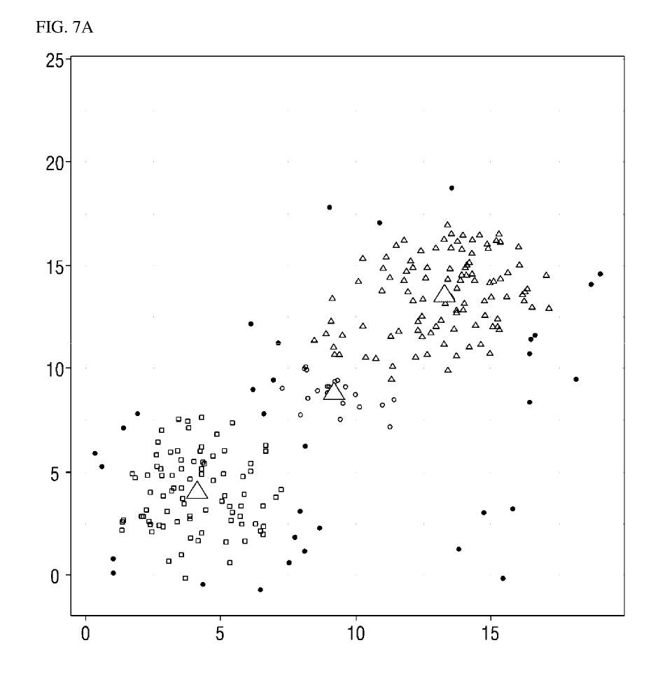

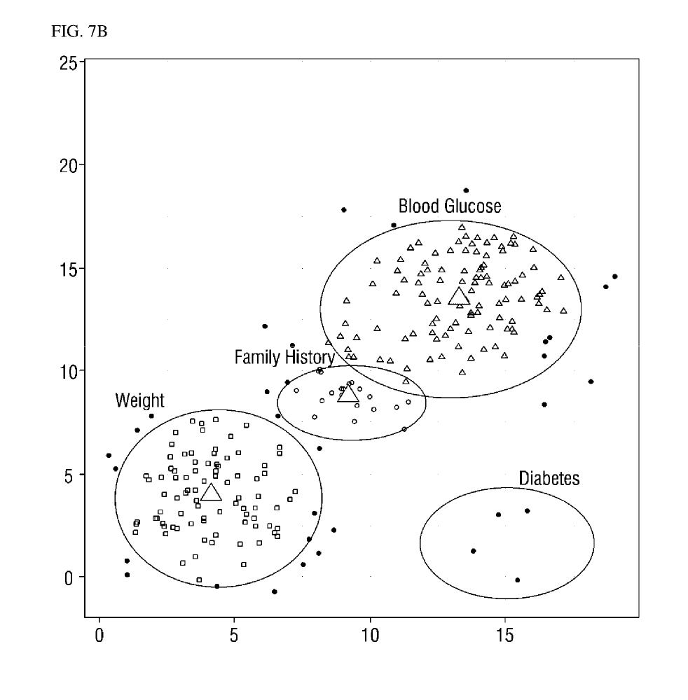

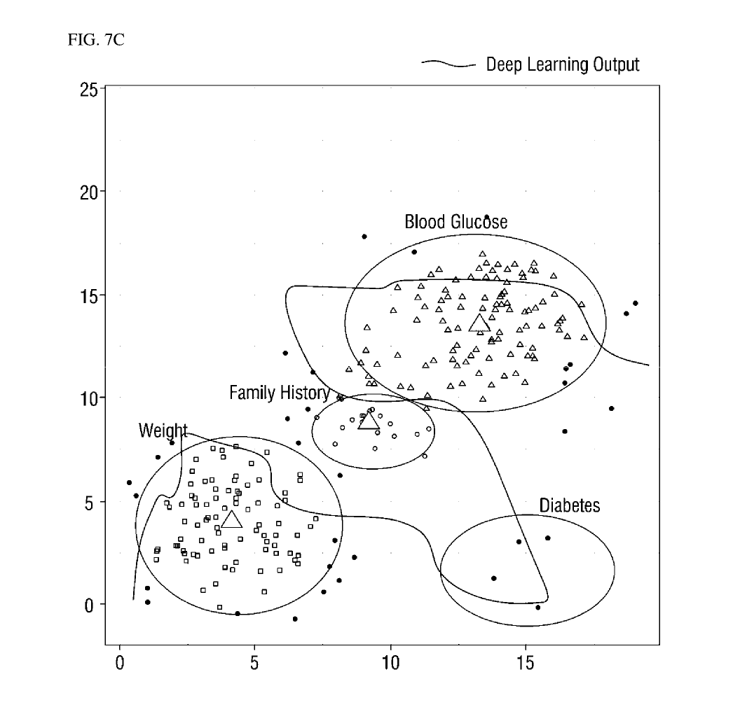

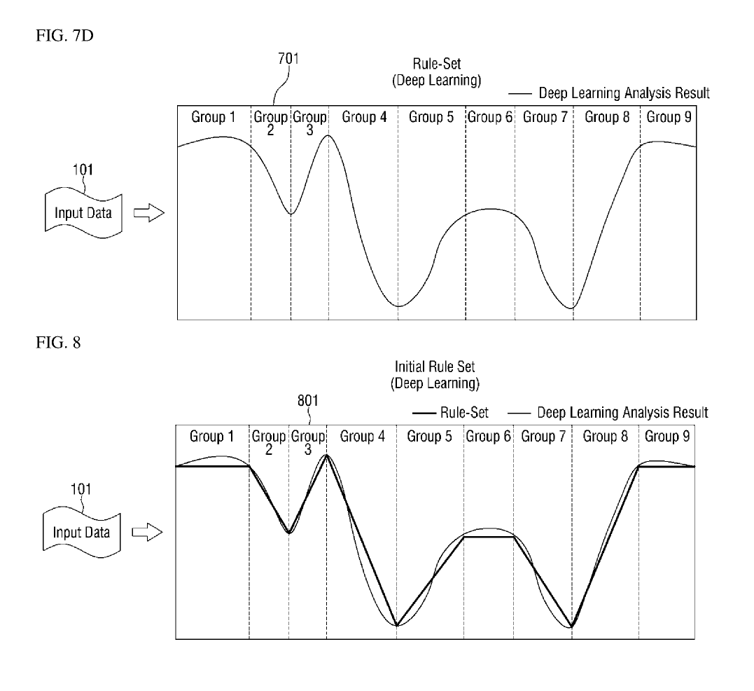

FIGS. 7A through 7D are diagrams for explaining result data obtained using a learned rule set obtained by deep learning.

In S30, the rule generation apparatus 100 may cluster the input data 101 into m groups (where m is a natural number greater than n, i.e., the number of rules included in the first rule set) by learning the input data 101.

The rule generation apparatus 100 may generate a training rule set including m rules based on the m groups. That is, the rule generation apparatus 100 may generate a training rule set having as many rules as, or more rules than, the first rule set. Accordingly, the rule generation apparatus 100 may additionally identify rules that affect the calculation of final result data.

FIG. 7A illustrates an example of input data. Referring to FIG. 7A, input data may each be arranged in a planar space according to their values

FIG. 7B shows an example of the result of clustering the input data of FIG. 7A using the deep learning module 111. The rule generation apparatus 100 may identify the density of input data based on the values of the input data. The rule generation apparatus 100 may identify and classify associations between clusters of input data using the deep learning module 111. Accordingly, the input data of FIG. 7A may be classified into “blood glucose”, “family history”, “eating habit”, and “diabetes” clusters.

Referring to FIG. 7C, the rule generation apparatus 100 may obtain result data by performing deep learning on each of the clusters of FIG. 7B. A curve drawn across each of the “blood glucose”, “family history”, “eating habit”, and “diabetes” clusters represents analysis result data obtained by deep learning. In S30, the rule generation apparatus 100 may generate a training rule set based on the deep learning analysis result data.

Referring to FIG. 7D, in S40, the rule generation apparatus 100 may obtain m-dimensional result data by executing the m rules included in the training rule set generated in S30. As a result, result data obtained by executing the training rule set may be located in an m-dimensional space, as shown in the graph 601 of FIG. 6.

However, according to exemplary embodiments of the present disclosure, the rule generation apparatus 100 applies the kernel function to the m-dimensional result data, thereby creating a 1D graph for the second result data obtained in S40. Referring to FIG. 7D, the deep learning analysis result data, i.e., the result data obtained by executing the training rule set, may be displayed as a 1D graph 701. Referring to the graph 701, Groups 1 through 9 denote clusters of the input data 101, and a curve represents the values of result data.

In response to the first result data being obtained, the rule generation apparatus 100 may output the graph 603 via the display unit or may transmit the graph 603 to an external device (not illustrated) via the network interface 122. In response to the second result data being obtain, the rule generation apparatus 100 may output the graph 701 of FIG. 7D via the display unit or may transmit the graph 701 of FIG. 7D to the external device via the network interface 122.

Alternatively, the rule generation apparatus 100 may output a graph obtained by overlapping the graphs 601 and 701 via the display unit or may transmit the graph obtained by overlapping the graphs 601 and 701 to the external device via the network interface 122. Accordingly, the administrator of the rule generation apparatus 100 or the user may intuitively compare first result data and second result data and may determine whether the first result data is normal.

FIG. 8 shows an exemplary graph comparing result data obtained using a predefined rule set that is set up in advance and result data obtained using a learned rule set, according to some exemplary embodiments of the present disclosure.

In S60, the rule generation apparatus 100 may compare the first result data obtained using the first rule set and the second result data obtained using the training rule set.

Referring to FIG. 8, a graph 801 is an exemplary graph for comparing the first result data and the second result data.

The rule generation apparatus 100 may store the second result data if a difference level less than a predefined reference level is identified between the first result data and the second result data.

The predefined reference level is a criterion for determining whether the difference level between the first result data and the second result data is such that a rule revision is required. That is, if there exists a difference level greater than the predefined reference level between the first result data and the second result data, the rule generation apparatus 100 may determine that the first rule set needs to be updated based on the training rule set to obtain highly accurate result data.

On the other hand, if the difference level between the first result data and the second result data is less than the predefined reference level, the rule generation apparatus 100 may determine that the update of the first rule set is not required, and may store the second result data as a log in order to use the second result data for deep learning. Since frequent rule updates are burdensome on the rule generation apparatus 100, the administrator of the rule generation apparatus 100 may appropriately determine the predefined reference level.

FIG. 8 shows a case where the first result data and the second result data have a difference level less than the predefined reference level, but the first result data and the second data may vastly differ over time. In the case of, for example, the rule sets 501 and 503 of FIG. 5, as new factors are discovered for checking for diabetes or existing rules used to check for diabetes change, the accuracy of the first result data obtained using the existing first rule set may gradually decrease, but the accuracy of the second result data obtained using the training rule set may gradually increase.

A case where first result data and second result data have a difference level greater than the predefined reference level will hereinafter be described with reference to FIG. 9.

FIG. 9 shows another exemplary graph comparing result data obtained using a predefined rule set that is set up in advance and result data obtained using a learned rule set, according to some exemplary embodiments of the present disclosure.

In S60, the rule generation apparatus 100 may compare first result data obtained by executing a first rule included in the first rule set on input data and second result data obtained by executing a second rule included in the training rule set on the input data.

Then, if a difference level greater than the predefined reference level is identified between the first result data and the second result data, the rule generation apparatus 100 may cluster the input data, and this is the case when the rule generation apparatus 100 determines that result data is abnormal.

The input data to be clustered may be input data producing a difference level greater than the predefined reference level between the first result data and the second result data.

Referring to FIG. 9, a cluster 911 including Groups 1 through 3, a cluster 913 including Groups 5 and 6, and a cluster 915 including Group 9 are clusters producing a difference level greater than the predefined reference level between their respective first and second result data.

The rule generation apparatus 100 may calculate result data for the input data 101 for each of the clusters 911, 913, and 915 by using the deep learning module 111.

If the accuracy of the calculated result data exceeds a predefined threshold value, the rule generation apparatus 100 may replace the first result data with the calculated result data. The accuracy of result data may be determined by calculating the recall rate using a statistical technique. That is, the accuracy of result data obtained by executing a rule set may be determined by comparing the result data with actual measurement data.

In the case of using, for example, the rule set 503 of FIG. 5, the accuracy of result data may be calculated by Equation (1):

Accuracy=(TP+TN)/(TP+TN+FP+FN)

where “TP” denotes the number of examinees that are determined to be diabetic based on their medical data and are actually diabetic, “TN” denotes the number of examinees that are determined to be nondiabetic based on their medical data and are actually nondiabetic, “EP” denotes the number of examinees that are determined to be diabetic based on their medical data but are actually nondiabetic, and “FN” denotes the number of examinees that are determined to be nondiabetic based on their medical data but are actually diabetic.

If the accuracy of the result data exceeds the predefined threshold value, the rule generation apparatus 100 may replace the first result data with the result data obtained by executing the training rule set.

Referring to FIG. 9, if the first rule included in the first rule set is a “weight” rule, the second rule included in the training rule set may also be a “weight” rule. If input data corresponding to Group 2 is weight change data, the rule generation apparatus 100 may replace the first result data, obtained by executing the first rule, with the second result data, obtained by executing the second rule. That is, the graph values corresponding to Group 2 may be replaced with the deep learning analysis result data.

Then, the rule generation apparatus 100 may learn the second rule based on the replaced result data. The rule generation apparatus 100 may apply the learned second rule in the training rule set. The rule generation apparatus 100 may continue to analyze second result data 1011 by using the deep learning module 111.

A method to apply the learned second rule in the training rule set will hereinafter be described with reference to FIG. 10. FIG. 10 is a diagram comparing a predefined rule set that is set up in advance and a learned rule set according to some exemplary embodiments of the present disclosure.

In order to learn the second rule, the rule generation apparatus 100 may generate predetermined data such as a table 1001 of FIG. 10.

Referring to FIG. 10, the table 1001 includes second result data obtained by executing the training rule set on input data corresponding to each of a “family history” cluster (i.e., Group 1), a “weight” cluster (i.e., Group 2), a “urine count” cluster (i.e., Group 3), a “blood glucose” cluster (i.e., Group 4), and an “amount of exercise” cluster (i.e., Group 5) and first result data obtained by executing the first rule set on the input data corresponding to each of the “family history” cluster, the “weight” cluster, the “urine count” cluster, the “blood glucose” cluster, and the “amount of exercise” cluster. The table 1001 may also include information indicating whether the result data is abnormal.

The table 1001 may include each of the first result data and the second result data in the form of a rule function, i.e., a function f(x). Alternatively, the table 1001 may include each of the first result data and the second result data as values of the function f(x).

The rule generation apparatus 100 may extract the function f(x) from the graph 901 of FIG. 9. Referring to FIG. 9, clusters 911, 913, and 915 each display the values of the first result data and the values of the second result data in the form of line graphs. The function f(x) may be extracted from each of the line graphs of each of the clusters 911, 913, and 915, and the second rule may be updated using the extracted functions.

For example, if the first rule included in the first rule set is the “weight” rule, the rule function of the first rule may be a linear equation, i.e., f(x)=−w*x+b, but the rule function of the second rule included in the training rule set may be a cubic equation, i.e., f(x)=−w*e²*x+b. That is, the rule function of the first rule may be modified by training performed by the deep learning module 111. Referring to the table 1001, in a case where input data x for the first rule is weight change data, the difference level between first result data and second result data exceeds a predefined reference level T.H.

If the accuracy of the second result data exceeds a predefined threshold value, the rule generation apparatus 100 may extract the rule function of the second rule and may apply the extracted rule function in the training rule set. Accordingly, in S60, the rule function of the first rule may be replaced with the rule function of the second rule.

Referring to a table 1003 of FIG. 10, x values of the rule functions of the first and second rules are weight change data. When the amount of weight change of patient 1 is 12 kg, the amount of weight change of patient 2 is 21 kg, and the amount of weight change of patient 3 is 9 kg, result data is output, indicating that patients 1 through 3 all have an abnormal weight, according to the first rule of the first rule set.

On the other hand, according to the second rule of the training rule set, result data is output indicating that patient 1 shows an abnormal weight change but patients 2 and 3 show a normal weight change. That is, the rule generation apparatus 100 may determine, through learning performed by the deep learning module 111, that the amount of weight change of patient 1 is abnormal and the amount of weight change of patients 2 and 3 is normal. The rule generation apparatus 100 may infer a new rule by analyzing result data. Then, the rule generation apparatus 100 may extract the rule function of the new rule and may apply the rule function of the new rule in the training rule set.

It has been described above how to update a rule through deep learning when first result data and second result data have a difference level greater than a predefined reference level. According to exemplary embodiments of the present disclosure, not only by performing deep learning, but also by analyzing result data using various analytic functions, optimized rules may be generated.

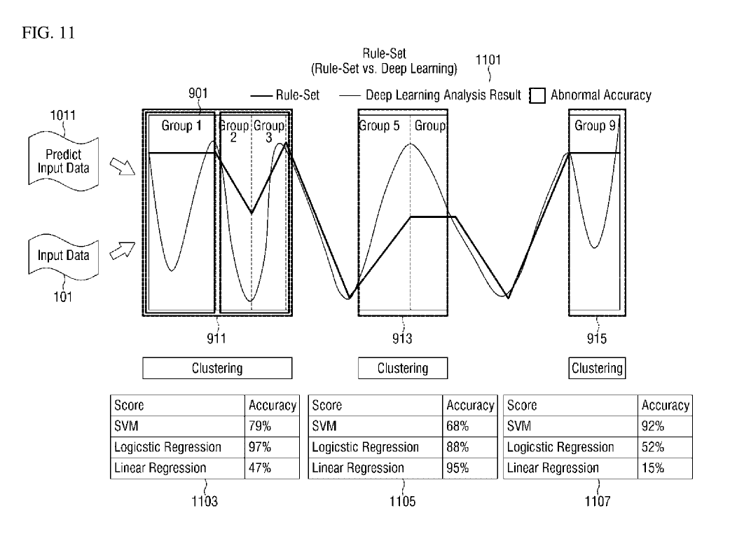

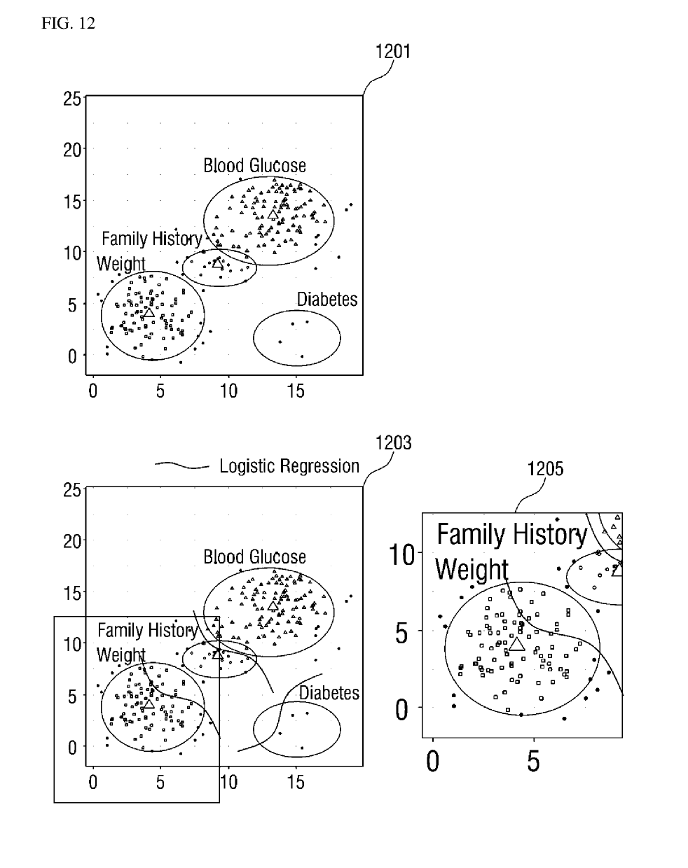

FIG. 11 is a diagram for explaining analytic functions that can be used in some exemplary embodiments of the present disclosure, and FIG. 12 is a diagram showing analysis result data obtained by deep learning and analysis result data obtained using the analytic functions.

The analytic functions that can be used in some exemplary embodiments of the present disclosure may include at least one of a linear regression function, a logistic regression function, and a support vector machine (SVM) function, but the present disclosure is not limited thereto. That is, the analytic functions that can be used in some exemplary embodiments of the present disclosure may include various functions that are already well known in the art, other than those set forth herein.

Referring to FIG. 11, the rule generation apparatus 100 may cluster input data that produces a difference level greater than a predefined reference level between first result data and second result data, as shown in a graph 1201 of FIG. 12, and may calculate result data for the clustered input data using analytic functions. The analytic functions may be, for example, the linear regression function, the logistic regression function, and the SVM function.

Specifically, the rule generation apparatus 100 may obtain result data for the input data of each of the clusters 911, 913, and 915 of FIG. 9 using each of the linear regression function, the logistic regression function, and the SVM function.

A graph 1101 of FIG. 11 only includes the clusters 911, 913, and 915 of FIG. 9. That is, the rule generation apparatus 100 may cluster only input data having abnormalities in its result data and may determine the result of the clustering as a subject for the calculation of accuracy. The rule generation apparatus 100 may calculate the accuracy of result data using Equation (1) above.

The rule generation apparatus 100 may choose one of the linear regression function, the logistic regression function, and the SVM function that yields the most accurate result data. Referring to tables 1103, 1105, and 1107 of FIG. 11, the logistic regression function shows the highest accuracy for the cluster 911, the linear regression function shows the highest accuracy for the cluster 913, and the SVM function shows the highest accuracy for the cluster 915

The rule generation apparatus 100 may choose one of the linear regression function, the logistic regression function, and the SVM function for each of the clusters 911, 913, and 915 and may learn a rule corresponding to each of the clusters 911, 913, and 915 using the chosen analytic function. Then, the rule generation apparatus 100 may apply the learned rules in the training rule set.

For example, it is assumed that in the case of the “weight” rule, result data produced by the logistic regression function is most accurate. A graph 1203 of FIG. 12 shows result data by learning weight-related clustered input data using the logistic regression function. A graph 1205 of FIG. 12 shows both result data obtained by executing the second rule of the training rule set on weight-related clustered input data and result data learned from the weight-related clustered input data using the logistic regression function.

The accuracy of the result data obtained by executing the second rule of the training rule set is 93% (=93(TP)+0(TN))/(93(TP)+0(TN)+0(FP)+7(FN)), and the accuracy of the result data obtained using the logistic regression function is 97%=(97(TP)+0(TN))/(97(TP)+0(TN)+0(FP)+3(FN)).

That is, for the weight-related clustered input data, the accuracy of result data obtained using an analytic function is higher than the accuracy of result data obtained using the training rule set generated by the deep learning module 111. The analytic function that yields high accuracy may vary depending on the attributes of clustered input data.

Alternatively, the rule generation apparatus 100 may calculate result data by readily applying an analytic function matched in advance to clustered input data according to the attributes of the clustered input data, instead of analyzing the accuracies of the linear regression function, the logistic regression function, and the SVM function and choosing one of the linear regression function, the logistic regression function, and the SVM function based on the result of the analysis. That is, the rule generation apparatus 100 may calculate result data for the cluster 911 of FIG. 11 by using the logistic regression function matched in advance to the cluster 911 of FIG. 11.

Then, if the accuracy of the calculated result data exceeds a predefined threshold value, the rule generation apparatus 100 may replace the first result data with the calculated result data and may learn the second rule of the training rule set based on the calculated result data.

Also, the rule generation apparatus 100 may apply the learned second rule in the training rule set.

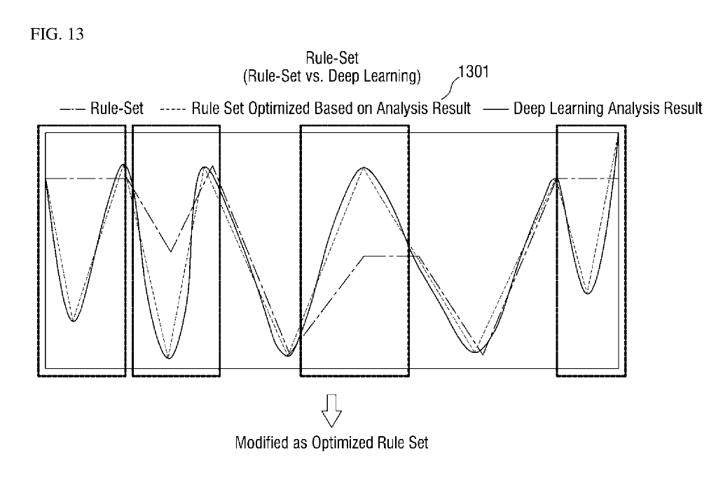

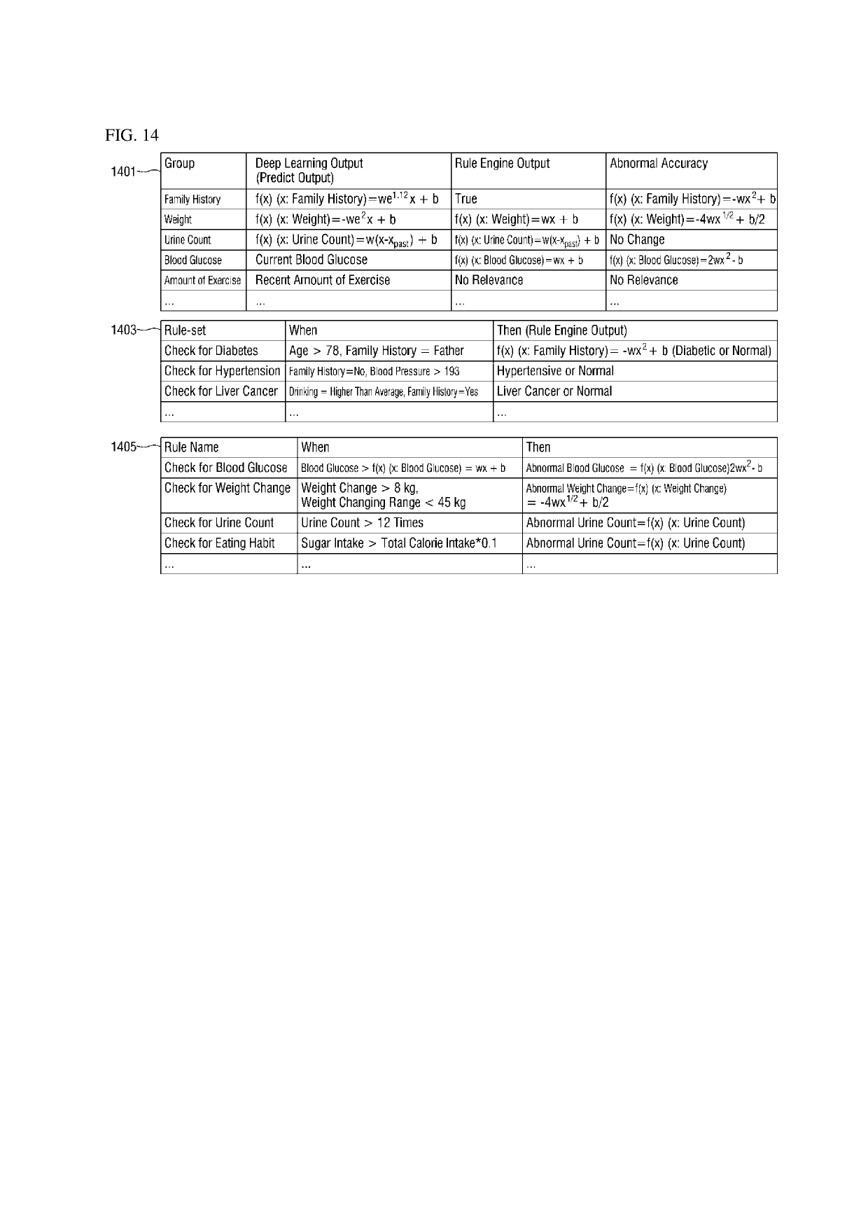

FIG. 13 is a diagram showing result data obtained using an optimized rule set according to some exemplary embodiments of the present disclosure. FIG. 14 is a diagram for explaining the optimized rule set according to some exemplary embodiments of the present disclosure.

FIG. 13 shows a graph 1301 in which first result data is replaced with second result data. That is, in the graph 1301, the first result data obtained by executing the rule engine on the input data 101 based on the first rule set is replaced with the second result data obtained by executing the rule engine on the input data 101 based on the training rule set. The rule generation apparatus 100 may apply the second result data in the training rule set by learning the second result data, and in S60, the first rule set may be updated to the second rule set having the training rule set applied therein.

Specifically, in S60, the rule generation apparatus 100 may compare the first result data obtained by executing the first rule of the first rule set on the input data 101 and the second result data obtained by executing the second rule of the training rule set on the input data 101. The rule generation apparatus 100 may delete the first rule from the first rule set or may add the second rule to the first rule set if a difference level greater than the predefined reference level is identified between the first result data and the second result data.

A rule update not only includes a rule revision, but also a rule deletion and a rule addition. In the case of a rule addition, the rule generation apparatus 100 may automatically add a rule to a rule set, or may recommend the addition of a new rule via the display unit or send a new rule addition message via the network interface 122.

Referring to FIG. 14, a table 1401 includes first rule set data obtained by executing the first rule set and second result data obtained by the training rule set. The table 1401 may also include result data obtained using an analytic function, for example, the logistic regression function. In order to update a rule set, the rule generation apparatus 100 may generate data such as the table 1401. Specifically, the rule generation apparatus 100 may include the result data obtained by using the analytic function in the table 1401 when the accuracy of the result data obtained by using the analytic function is higher than the accuracy of the second result data.

FIG. 14 shows a case where the rules included in the training rule set are learned and updated by analyzing the result data obtained using the analytic function and are then applied back in the training rule set, i.e., a case where the accuracy of the result data obtained using the analytic function is higher than the accuracy of the result data obtained using the training rule set generated by the deep learning module 111.

Referring to the table 1401 of FIG. 14, the “amount of exercise” rule has been deleted from the final rule set, and the “family history”, “weight”, and “blood glucose” rules have been revised.

Tables 1403 and 1405 of FIG. 14 show an updated rule set and rule functions. Referring to the table 1403, the accuracy of the “check for diabetes” rule can be improved simply using family history-related input data included in the cluster 911 of FIG. 9. Referring to the table 1405, the rule conditions and rule functions of the “check for blood glucose” and “check for weight change” rules, which are individual rules for checking for diabetes, have been revised. The rule generation apparatus 100 may store the revised rule sets and rule functions.

Exemplary embodiments of the present disclosure have been described above taking medical data as exemplary input data, but the rule generation apparatus 100 may be used in various fields other than the medical field. That is, once a predefined rule set matched to input data is set for the first time, a training rule set can be generated, regardless of the type of the input data, using the deep learning module 111, and can be updated later using the deep learning module 111 and an analytic function. Accordingly, the accuracy of result data can be automatically enhanced without the need to manually update the rule set.

In a brokerage firm, for example, a rule set may be set up for a quick decision-making to buy and sell stocks and may be updated every six months according to the change of the circumstances. The interval of updating the rule set is arbitrarily determined. Thus, if the rule set is updated arbitrarily, the accuracy of result data obtained by executing the rule set cannot be uniformly maintained.

In this case, the rule generation apparatus 100 can uniformly maintain the accuracy of the result data by issuing a notice in advance or automatically updating the rule set.

Also, many factories manufacturing industrial products such as tires use a rule set for setting and testing performance and cost targets during product development. However, even if a rule set is used during product development, it is very difficult to verify whether the initially-set targets and their testing methods are appropriate, i.e., whether the rule set used is appropriate, after product release.

In this case, the rule generation apparatus 100 may learn actual product quality measurement data, obtained after product release, through deep learning. Then, the rule generation apparatus 100 may determine whether the rule set used is appropriate or needs a rule revision, and may recommend which rule should be revised or automatically revise the rule set used, if a rule revision is needed.

The subject matter described in this specification can be implemented as code on a computer-readable recording medium. The computer-readable recording medium may be, for example, a removable recording medium, such as a CD, a DVD, a Blu-ray disc, a USB storage device, or a removable hard disk, or a fixed recording medium, such as a ROM, a RAM, or a hard disk embedded in a computer. A computer program recorded on the computer-readable recording medium may be transmitted from one computing device to another computing device via a network such as the Internet to be installed and used in the other computing device.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the exemplary embodiments described above should not be understood as requiring such separation in all exemplary embodiments, and it should be understood that the described program components and systems can generally be integrated together in a single software product or packaged into multiple software products.

What is claimed is:

1. A rule generation method of a rule generation apparatus, the rule generation method comprising:
obtaining first result data by executing a rule engine on input data based on a predetermined first rule set;
generating a training rule set by analyzing the input data using a deep learning module;
obtaining second result data by executing the rule engine on the input data based on the generated training rule set;
comparing the first result data and the second result data; and
based on a result of the comparison, updating the predetermined first rule set to a second rule set using the training rule set.

2. The rule generation method of claim 1, wherein the first result data is obtained by executing a first rule included in the predetermined first rule set on the input data, and the second result data is obtained by executing a second rule included in the training rule set on the input data, and
wherein the updating of the predetermined first rule set to the second rule set comprises clustering the input data if a difference level greater than a predetermined reference level is identified between the first result data and the second result data.

3. The rule generation method of claim 1, wherein the updating the predetermined first rule set to the second rule set comprises storing the second result data if a difference level less than a predetermined reference level is identified between the first result data and the second result data.

4. The rule generation method of claim 1, wherein the first result data is obtained by executing a first rule included in the predetermined first rule set, and the second result data is obtained by executing a second rule included in the training rule set; and
wherein the updating of the predetermined first rule set to the second rule set comprises deleting the first rule included in the predetermined first rule set if a difference level greater than a predefined reference level is identified between the first result data and the second result data.

5. The rule generation method of claim 1, wherein the generating of the training rule set comprises:
clustering the input data into m groups by analyzing the input data; and
generating the training rule set including m rules from the m groups.

6. The rule generation method of claim 5, further comprising:
calculating result data corresponding to the clustered input data using the deep learning module;
in response to an accuracy value of the calculated result data exceeding a predetermined threshold value, replacing the first result data with the calculated result data;
analyzing a second rule included in the training rule set based on the calculated result data; and
including the analyzed second rule in the training rule set.

7. The rule generation method of claim 6, wherein the analyzing the second rule comprises:
extracting a rule function input to a first rule included in the predetermined first rule set for the input data; and
updating the second rule using the extracted rule function.

8. The rule generation method of claim 7, further comprising:
calculating analysis result data corresponding to the clustered input data using predetermined analytic functions;
selecting an analytic function from among the predetermined analytic functions, wherein the selected analytic function yields analysis result data having a highest accuracy from among accuracies corresponding to the predetermined analytic functions;
analyzing the second rule based on the selected analytic function; and
including the analyzed second rule in the training rule set.

9. The rule generation method of claim 5, further comprising:
calculating result data using an analytic function selected in advance, according to an attribute of the clustered input data;
in response to an accuracy value of the calculated result data exceeding a predetermined threshold value, replacing the first result data with the calculated result data;
analyzing a second rule included in the training rule set based on the calculated result data; and
including the analyzed second rule in the training rule set.
